(19) United States
(12) Patent Application Publication
(10) Pub. No.: US 2006/0058409 A1
(43) Pub. Date: Mar. 16, 2006

(54) Method for producing rigid polyurethane foams by means of graft polyhydric alcohols

(76) Inventors: Bernd Zaschke, Schonfeld (DE); Andreas Emge, Lemforde (DE); Gottfried Knorr, Schwarzheide (DE); Peter Von Malotki, Lemforde (DE); Holger Seifert, Bohmte (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/530,707

(22) PCT Filed: Oct. 6, 2003
(86) PCT No.: PCT/EP03/11014

§ 371 Date: Apr. 8, 2005

(30) Foreign Application Priority Data
Oct. 15, 2002 (DE) 102-48-084.2

(51) Int. Cl. C08G 18/00

(52) U.S. Cl. 521/155

(57) ABSTRACT

The invention relates to a process for producing rigid polyurethane foams by reacting a) polyisocyanates with b) compounds having at least two hydrogen atoms reactive toward isocyanate groups, in the presence of c) catalysts, and d) blowing agents, where, among the compounds having at least two hydrogen atoms reactive toward isocyanate groups, there is at least one graft polyol present capable of preparation via in-situ polymerization of ethylenically unsaturated monomers in polyether alcohols.

The invention relates to a process for producing rigid polyurethane foams by reacting polyisocyanates with compounds having at least two hydrogen atoms reactive toward isocyanate groups.

Rigid polyurethane foams have been known for a long time, and are mainly used for thermal insulation, e.g. in refrigeration equipment, in tanks for storing hot water, in long-distance heating pipes, or in the construction sector, for example in sandwich components. An overview of the production and use of rigid polyurethane foams is found by way of example in Kunststoff-Handbuch, Volume 7, Polyurethanes, 1^{st} Edition, 1966, edited by Dr. R. vieweg and Dr. A. Höchtlen, 2^{nd} Edition 1983, edited by Dr. Günter Oertel, and 3^{rd} Edition 1993, edited by Dr. Günter Oertel, Carl Hanser Verlag, Munich, Vienna.

In the industrial production of rigid polyurethane foams, in particular of sandwich components, or the production of refrigeration equipment, the curing of the foams is particularly important.

Faster demolding times increase the capacity of existing production lines with no need for investment in re-engineering of machinery. When sandwich components are produced, faster curing permits higher twin-belt speed, and thus higher output per unit of time.

The prior art discloses many ways of lowering demolding times.

For example, DE19630787 describes polyurethanes with improved curing via the use of amine-containing polyols.

CA 2135352 describes polyurethanes with good demolding performance via the use of a sucrose-started polyol.

According to JP 07082335, demolding is improved by using a mixture of 1,3,5-tris(3-aminopropyl)hexahydro-s-triazine, pentamethyldiethylenetriamine, and bis(2-dimethylaminoethyl) ether as catalysts.

According to JP 2001158815, good demolding is achieved via the use of a mixture of aromatic polyester alcohols having a hydroxy value in the range from 405 to 500 mg KOH/g and a functionality of from 2 to 3 with polyether alcohols based on TDA and propylene oxide and/or butylene oxide having a hydroxy value of from 300 to 450 mg KOH/g and a functionality of from 3 to 4.

According to JP 10101762, good demolding is achieved via a sucrose-alkylene-oxide polyol with a molecular weight above 300 and a functionality above 3.

According to JP 02180916, good demolding is achieved via an aromatic polyesterol having a functionality of from 2.2 to 3.6 and a hydroxy value of from 200 to 550 mg KOH/g, prepared by esterifying an aromatic polycarboxylic acid with diethylene glycol and with a trifunctional alcohol.

For foams to be used in refrigeration equipment, and also for sandwich components, operations therefore typically use modified catalysis and/or use amine-started polyols which are highly functionalized or have intrinsic reactivity and have a high hydroxy value, with the aim of achieving a high level of crosslinking and thus faster curing.

The higher level of crosslinking frequently impairs the flowability of the reaction mixture, thus requiring more material in order to fill a cavity (e.g. a mold or a refrigerator casing).

It is an object of the present invention to provide rigid polyurethane foams which feature good curing and demoldability together with ideal flow performance, while having good mechanical properties, in particular good compressive strength.

We have found that this object is achieved, surprisingly, in that the polyol component is composed to some extent or completely of graft polyols.

The invention therefore provides a process for producing rigid polyurethane foams by reacting
a) polyisocyanates with
b) compounds having at least two hydrogen atoms reactive toward isocyanate groups, in the presence of
c) catalysts, and
d) blowing agents,
   which comprises the presence, among the compounds having at least two hydrogen atoms reactive toward isocyanate groups, of at least one graft polyol capable of preparation via in-situ polymerization of ethylenically unsaturated monomers in polyether alcohols.

The rigid polyurethane foams produced according to the invention are usually closed-cell foams, and this means that the proportion of closed cells in the foam is at least 88%, preferably at least 95%.

The amount used of the graft polyols used according to the invention may be up to 100% by weight. The preferred amount used is from 0.5 to 70% by weight, based in each case on component b.

The preferred amount of the graft polyols used when producing refrigeration equipment is from 3 to 70% by weight, particularly from 3 to 50% by weight, in particular from 3 to 35% by weight, based in each case on the weight of component b.

The preferred amount of the graft polyols used during the production of sandwich components is from 0.5 to 35% by weight, with preference from 0.5 to 25% by weight, and particularly from 1 to 20% by weight, based in each case on the weight of component b.

The polyol mixtures comprising the graft polyols mostly have a relatively low storage stability. To render the systems processable during the production of refrigeration equipment, continuous stirring throughout the machine-foaming process is preferred.

For the production of sandwich components, it is preferable to use a suitable polyol, such as polypropylene glycols with a molar mass in the range from 300 to 1500 g/mol with the graft polyol to formulate an addition component, which then has phase stability extending over weeks to months. This is then metered into the other components in the mixing head. The storage stability of the polyol mixtures may be further increased via the presence of conventional silicone stabilizers.

The graft polyols used for the process of the invention usually have a hydroxy value in the range from 20 to 120 mg KOH/g. They may be prepared by conventional and known processes.

The graft polyols used according to the invention, often also termed polymer polyols, are dispersions of polymers, mostly acrylonitrile-styrene copolymers, in a polyether alcohol.

Graft polymers may be prepared via free-radical polymerization of the monomers, preferably acrylonitrile, styrene, and also, where appropriate, other monomers, or of a macromer, or of a moderator, using a free-radical initiator, mostly azo compounds or peroxide compounds, in a continuous phase of polyetherol or polyesterol, often termed carrier polyols.

Graft polyols are prepared by in-situ polymerization of acrylonitrile, styrene, or preferably mixtures of styrene and acrylonitrile, e.g. in a weight ratio of from 90:10 to 10:90, preferably from 70:30 to 30:70, using methods based on the data in German Patents 1111394, 1222669 (US 3304273, 3383351, 3523093), 1152536 (GB 1040452), and 1152537 (GB 987618).

Carrier polyols which may be used are compounds having at least a functionality of from 2 to 8, preferably from 2 to 6, and an average molar mass of from 300 to 8000 g/mol, preferably from 300 to 5000 g/mol. The hydroxy value of the polyhydroxy compounds here is generally from 20 to 160 and preferably from 28 to 56.

Macromers, also termed stabilizers, are linear or branched polyetherols with molar masses ≧1000 g/mol, containing at least one terminal, reactive olefinic unsaturated group. The ethylenically unsaturated group may be introduced by subjecting a previously prepared polyol to reaction with carboxylic anhydrides, such as maleic anhydride, with fumaric acid, with acrylate derivatives, with methacrylate derivatives, or else with isocyanate derivatives, such as 3-isopropenyl-1,1-dimethylbenzyl isocyanates, or isocyanatoethyl methacrylates. Another route is preparation of a polyol via alkoxidation of propylene oxide and ethylene oxide, using starter molecules having hydroxy groups and ethylenic unsaturation. Examples of these macromers are described in the patents U.S. Pat. No. 4,390,645, U.S. Pat. No. 5,364,906, EP 0 461 800, U.S. Pat. No. 4,997,857, U.S. Pat. No. 5,358,984, U.S. Pat. No. 5,990,232, WO 01/04178, and U.S. Pat. No. 6,013,731.

During the free-radical polymerization, the macromers become incorporated into the copolymer chain. The result is formation of block copolymers having a polyether block and a polyacrylonitrile-styrene block. These act as compatibilizer in the boundary between continuous and disperse phase, and suppress agglomeration of the graft polyol particles. The proportion of the macromers is usually from 1 to 15% by weight, based on the total weight of the monomers used to prepare the graft polyol.

Moderators, also termed chain transfer agents, are usually used in the preparation of graft polyols. The use and the function of these moderators is described by way of example in U.S. Pat. No. 4,689,354, EP 0 365 986, EP 0 510 533, and EP 0 640 633, EP 008 444, EP 0731 118 B1. Moderators reduce the molecular weight of the copolymers as they form, by subjecting the growing free radical to chain transfer. This reduces the level of crosslinking between the polymer molecules, and thus affects the viscosity and the dispersion stability of the graft polyols, and also their filterability. The proportion of the moderators is usually from 0.5 to 25% by weight, based on the total weight of the monomers used to prepare the graft polyol. Moderators usually used to prepare graft polyols are alcohols, such as 1-butanol, 2-butanol, isopropanol, ethanol, methanol, cyclohexane, toluene, mercaptans, such as ethanethiol, 1-heptanethiol, 2-octanethiol, 1-dodecanethiol, thiophenol, 2-ethylhexyl thioglycolate, methyl thioglycolate, cyclohexyl mercaptan, and also enol ether compounds, morpholine, and α(benzoyloxy)styrene.

To initiate the free-radical polymerization, use is usually made of peroxide compounds or of azo compounds for example dibenzoyl peroxide, lauroyl peroxide, tert-amyl 2-ethylperoxyhexanoate, di-tert-butyl peroxide, diisopropyl peroxide carbonate, tert-butyl 2-ethylperoxyhexanoate, tert-butyl perpivalate, tert-butyl perneodecanoate, tert-butyl perbenzoate, tert-butyl percrotonate, tert-butyl perisobutyrate, tert-butyl 1-methylperoxypropanoate, tert-butyl 2-ethylperoxypentanoate, tert-butyl peroxyoctanoate, and di-tert-butyl perphthalate, 2,2′-azobis(2,4-dimethylvalereronitrile), 2,2′-azobisisobutyronitrile (AIBN), 2,2′-azobis(dimethyl isobutyrate), 2,2′-azobis(2-methylbutyronitrile) (AMBN), 1,1′-azobis(1-cyclohexanecarbonitrile). The proportion of the initiators is usually from 0.1 to 6% by weight, based on the total weight of the monomers used to prepare the graft polyol.

For reasons associated with the reaction rate of the monomers, together with the half-life time of the initiators, the free-radical polymerization to prepare graft polymers is usually carried out at from 70 to 150° C. and at a pressure of up to 20 bar. Preferred reaction conditions for preparing graft polyols are from 80 to 140° C. at a pressure of from atmospheric pressure to 15 bar.

In one embodiment of the process of the invention, the graft polyols used for the process of the invention may be prepared using carrier polyols whose properties are similar to those of conventional and known flexible-foam polyether alcohols. These polyether alcohols mostly have a functionality of from 2 to 8 and a hydroxy value in the range from 20 to 100 mg KOH/g. They are prepared by an addition reaction of propylene oxide, or of mixtures of ethylene oxide and propylene oxide, onto H-functional starter substances, such as glycerol, trimethylolpropane, or glycols, e.g. ethylene glycol or propylene glycol. The catalysts used for the addition reaction of the alkylene oxides may comprise bases, preferably alkali metal hydroxides, or multimetal cyanide complexes, known as DMC catalysts. These graft polyols mostly have a hydroxy value in the range from 10 to 70 mg KOH/g, with a solids content of from 35 to 60%.

In one particular embodiment of the process of the invention, the carrier polyols used comprise the type of polyether alcohols usually used to produce rigid polyurethane foams. These polyether alcohols mostly have a functionality of from 2 to 8 and a hydroxy value in the range from 100 to 800 mg KOH/g. The starter substances used comprise polyhydric alcohols, such as glycerol, trimethylolpropane, or sugar alcohols, such as sorbitol, sucrose, or glucose, or aliphatic amines, such as ethylenediamine, or aromatic amines, such as tolylenediamine (TDA), diphenylmethanediamine (MDA), or mixtures of MDA and polyphenylene polymethylene polyamines. The alkylene oxides used comprise propylene oxide or mixtures of ethylene oxide and propylene oxide. These graft polyols mostly have a hydroxy value in the range from 60 to 150 mg KOH/g with a solids content of from 35 to 60%.

The crosslinking densities achievable for the polyurethane network are higher when using these graft polyols than when using the known graft polyols based on flexible-foam carrier polyols.

The graft polyols used according to the invention preferably have a particle size of from 0.1 to 8 μm for the polymers, preferably from 0.2 to 4 μm, with a particle size maximum at from 0.2 to 3 μm, preferably at from 0.2 to 2.0 μm. The solids content of the graft polyols is mostly in the range from 10 to 60% by weight, based on the polyol.

Among these graft polyols, those whose use is preferred are based on carrier polyols which are polyether alcohols which have a hydroxy value of from 130 to 240 mg KOH/g and whose starter substance is vicinal TDA, which is subjected to an addition reaction with propylene oxide or with a mixture of from 5 to 12% by weight of ethylene oxide and from 88 to 95% by weight of propylene oxide. The resultant graft polyols preferably have a hydroxy value of from 70 to 100 mg KOH/g and a solids content of from 40 to 55% by weight, based on the entire graft polyol. The monomers used preferably comprise a mixture of acrylonitrile and styrene in a ratio by weight of from 1:3 to 3:1, preferably 1:2.

In another embodiment of these graft polyols, the carrier polyols used comprise polyether alcohols which have a hydroxy value in the range from 140 to 240 mg KOH/g and which are prepared by an addition reaction of alkylene oxides, in particular propylene oxide or a mixture of propylene oxide and ethylene oxide, onto conventional di- or trifunctional starter substances, such as glycols, glycerol, and/or trimethylolpropane. These graft polyols preferably have a hydroxy value in the range from 70 to 110 mg KOH/g and a solids content of from 30 to 70% by weight, based on the weight of the entire graft polyol.

In another preferred embodiment of the graft polyols used according to the invention, the particle size distribution is bimodal, meaning that the particle size distribution curve has two maxima. One way of preparing these graft polyols is the mixing of graft polyols with monomodal particle size distribution and with different particle size, in the appropriate ratio. In another method, however, the initial charge for the reaction comprises a carrier polyol which is a polyol containing polymers of olefinically unsaturated monomers. In this embodiment, too, the particle size is within the range described above.

The graft polyols used according to the invention may be prepared in continuous processes or in batch processes. The synthesis of graft polyols by both types of process is known, and there are many descriptions of examples. For example, the synthesis of graft polyols by semibatch processes is described in the following patents: EP 439755, U.S. Pat. No. 4,522,976, EP 163188, U.S. Pat. No. 5,830,944, EP 894812, U.S. Pat. No. 4,394,491 A, WO 87/03886, WO 97/44368, U.S. Pat. No. 5,554,662. A specific form of the semibatch process is the semibatch seed process, in which the initial charge used for the reaction also comprises a graft polyol as seed, as described in EP 510533, EP 786480, and EP 698628, for example. The synthesis of graft polyols by a continuous process is also known, and is described, inter alia, in WO 00/59971, WO 99/31160, U.S. Pat. No. 5,955,534, U.S. Pat. No. 5,496,894, U.S. Pat. No. 5,364,906, U.S. Pat. No. 5,268,418, U.S. Pat. No. 6,143,803, EP 0768324.

The following comments concern the other starting materials used for the process of the invention:

The organic polyisocyanates a) used preferably comprise aromatic polyfunctional isocyanates.

Individual compounds which may be mentioned by way of example are: tolylene 2,4- and 2,6-diisocyanate (TDI) and the corresponding isomer mixtures, diphenylmethane 4,4′-2,4′-, and 2,2′-diisocyanate (MDI) and the corresponding isomer mixtures, mixtures of diphenylmethane 4,4′- and 2,4′-diisocyanates, polyphenyl polymethylene polyisocyanates, mixtures of diphenylmethane 4,4′-, 2,4′-, and 2,2′-diisocyanates and polyphenyl polymethylene polyisocyanates (crude MDI), and mixtures of crude MDI and tolylene diisocyanates. The organic di- and polyisocyanates may be used individually or in the form of mixtures.

Use is also often made of what are known as modified polyfunctional isocyanates, i.e. products obtained by chemical reaction of organic di- and/or polyisocyanates. Examples which may be mentioned are di- and/or polyisocyanate containing isocyanurate groups and/or containing urethane groups. The modified polyisocyanates may, where appropriate, be mixed with one another or with unmodified organic polyisocyanates, e.g. diphenylmethane 2,4′-, or 4,4′-diisocyanate, crude MDI, 2,4-tolylene and/or 2,6-diisocyanate.

Besides these, use may also be made of reaction products of polyfunctional isocyanates with polyhydric polyols, or else of mixtures of these with other di- or polyisocyanates.

An organic polyisocyanate which has proven particularly successful is crude MDI with an NCO content of from 29 to 33% by weight and with a viscosity in the range from 150 to 1000 mPa·s at 25° C.

The compounds b which are used and which have at least two hydrogen atoms reactive toward isocyanate, and which may be used together with the graft polyols used according to the invention, are in particular polyether alcohols and/or polyester alcohols having hydroxy values in the range from 100 to 1200 mg KOH/g.

The polyester alcohols used together with the graft polyols used according to the invention are mostly obtained via condensation of polyhydric alcohols, preferably diols, having from 2 to 12 carbon atoms, preferably from 2 to 6 carbon atoms, with polybasic carboxylic acids having from 2 to 12 carbon atoms, such as succinic acid, glutaric acid, adipic acid, subaric acid, azelaic acid, sebacic acid, decanedicarboxylic acid, maleic acid, fumaric acid, or preferably phthalic acid, isophthalic acid, terephthalic acid, or the isomeric naphthalenedicarboxylic acids.

The polyether alcohols used together with the graft polyols used according to the invention mostly have a functionality of from 2 to 8, in particular from 3 to 8.

Use is particularly made of polyether polyols which are prepared by known processes, for example via anionic polymerization of alkylene oxides in the presence of catalysts, preferably of alkali metal hydroxides.

The alkylene oxides used are mostly ethylene oxide and/or propylene oxide, preferably pure propylene 1,2-oxide.

Particular starter molecules which may be used are compounds having at least 3, preferably from 4 to 8, hydroxy groups, or having at least two primary amino groups.

The starter molecules used and having at least 3, preferably from 4 to 8, hydroxy groups are preferably trimethylolpropane, glycerol, pentaerythritol, sugar compounds, such as glucose, sorbitol, mannitol, and sucrose, polyhydric phenols, resols, e.g. oligomeric condensation products of phenol and formaldehyde, and Mannich condensates of phenols with formaldehyde and with dialkanolamines, or else melamine.

The starter molecules used and having at least two primary amino groups are preferably aromatic di- and/or polyamines, such as phenylenediamine, 2,3-, 2,4-, 3,4-, and 2,6-tolylenediamine, and 4,4′-, 2,4′-, and 2,2′-diaminodiphenylmethane, or else aliphatic di- and polyamines, e.g. ethylenediamine.

The polyether polyols have a functionality which is preferably from 3 to 8, and hydroxy values which are preferably from 100 to 1200 mg KOH/g, and in particular from 240 to 570 mg KOH/g.

The use of difunctional polyols, such as polyethylene glycols, and/or polypropylene glycols—with molecular weight in the range from 500 to 1500—in the polyol component can adjust the viscosity of the polyol component appropriately.

The compounds b having at least two hydrogen atoms reactive toward isocyanate also include any chain extenders and crosslinkers used concomitantly. The rigid PU foams may be produced with or without concomitant use of chain extenders and/or of crosslinkers. Addition of bifunctional chain extenders or of crosslinkers of functionality 3 or higher, or where appropriate, of mixtures of these can prove advantageous for modifying mechanical properties. The chain extenders and/or crosslinkers used preferably comprise alkanolamines and in particular diols and/or triols with molecular weights which are smaller than 400 and are preferably from 60 to 300.

The amount advantageously used of chain extenders, crosslinkers, or mixtures of these is advantageously from 1 to 20% by weight, preferably from 2 to 5% by weight, based on the polyol component b.

Further data concerning the polyester alcohols and polyether alcohols used, and also concerning their preparation, is found by way of example in Kunststoffhandbuch, Volume 7 “Polyurethane”, edited by Günter Oertel, Carl-Hanser-Verlag Munich, 3^{rd} Edition, 1993.

The catalysts c used are in particular compounds which accelerate the reaction of the isocyanate groups with the groups reactive toward isocyanate groups.

These catalysts comprise strongly basic amines, e.g. secondary aliphatic amines, imidazoles, amidines, and also alkanolamines or organometallic compounds, in particular organotin compounds.

If isocyanurate groups are also to be incorporated into the rigid polyurethane foam, specific catalysts are needed for this purpose. The usual isocyanurate catalysts used are metal carboxylates, in particular potassium acetate and solutions thereof.

Depending on requirement, the catalysts may be used alone or in any desired mixtures with one another.

The blowing agents d used may preferably be water, which reacts with isocyanate groups, with elimination of carbon dioxide. In combination with, or instead of, water it is also possible to use what are known as physical blowing agents. These are compounds inert toward the starting components, mostly liquid at room temperature, and vaporizing under the conditions of the urethane reaction. The boiling point of these compounds is preferably below 50° C. Physical blowing agents also include compounds which are gaseous at room temperature and which are introduced into, or dissolved in, the starting components under pressure, examples being carbon dioxide, and low-boiling alkanes and fluoroalkanes.

The compounds are mostly selected from the group consisting of alkanes and cycloalkanes having at least 4 carbon atoms, dialkyl ethers, esters, ketones, acetals, fluoroalkanes having from 1 to 8 carbon atoms, and tetraalkylsilanes having from 1 to 3 carbon atoms in the alkyl chain, in particular tetramethylsilane.

Examples which may be mentioned are propane, n-butane, iso- and cyclobutane, n-, iso-, and cyclopentane, cyclohexane, dimethyl ether, methyl ethyl ether, methyl butyl ether, methyl formate, acetone, and fluoroalkanes, where these compounds can be degraded in the troposphere and are therefore not injurious to the ozone layer, examples being trifluoromethane, difluoromethane, 1,1,1,3,3-pentafluorobutane, 1,1,1,3,3-pentafluoropropane, 1,1,1,2-tetrafluoroethane, difluoroethane, and heptafluoropropane. It is preferable to use hydrocarbons containing no halogen atoms, in particular pentane, if appropriate mixed with propane and with butanes. The physical blowing agents mentioned may be used alone or in any desired combinations with one another.

The process of the invention may, if required, be carried out in the presence of flame retardants, and also of conventional auxiliaries and/or additives.

Flame retardants which may be used are phosphoric esters and/or phosphonic esters. It is preferable to use compounds which are not reactive toward isocyanate groups. Preferred compounds also include chlorine-containing phosphoric esters.

Typical representatives of this group of flame retardants are triethyl phosphate, diphenyl cresyl phosphate, tris(chloropropyl) phosphate, and diethyl ethanephosphonate.

Besides these, use may also be made of bromine-containing flame retardants. The bromine-containing flame retardants used are preferably compounds having groups reactive toward the isocyanate group. Compounds of this type are esters of tetrabromophthalic acid with aliphatic diols, and alkoxylation products of dibromobutenediol. Use may also be made of compounds derived from the series of brominated neopentyl compounds containing OH groups.

The auxiliaries and/or additives used comprise the substances known per se for this purpose, examples being surface-active substances, foam stabilizers, cell regulators, fillers, pigments, dyes, flame retardants, hydrolysis stabilizers, antistats, and agents with fungistatic and bacteriostatic action.

Further details concerning the starting materials, blowing agents, catalysts, and auxiliaries and/or additives used to carry out the process of the invention are found by way of example in Kunststoffhandbuch, Volume 7, “polyurethane” Carl-Hanser-Verlag, Munich, 1^{st} Edition, 1966, 2^{nd} Edition, 1983 and 3^{rd} Edition, 1993.

To produce the rigid polyurethane foams, the polyisocyanates a and the compounds b having at least two hydrogen atoms reactive 15 toward isocyanate groups are reacted in amounts such that the isocyanate index is in the range from 100 to 220, preferably from 115 to 195. The rigid polyurethane foams may be produced batchwise or continuously with the aid of known mixing apparatus.

A higher index, preferably up to 350, may also be used when producing polyisocyanurate foams.

The rigid PU foams of the invention are usually produced by the two-component process. This process prepares a mixture using the compounds b having at least two hydrogen atoms reactive toward isocyanate groups, the flame retardants, the catalysts c, the blowing agents d, and also the other auxiliaries and/or additives, to give what is known as a polyol component, and reacts this with the polyisocyanates or mixtures of the polyisocyanates and, where appropriate, blowing agents, also termed the isocyanate component.

The starting components are mostly mixed at from 15 to 35° C., preferably from 20 to 30° C. Using high- or low-pressure metering machinery, the reaction mixture may be poured into closed support molds. An example of the use of this technology is the batchwise manufacture of sandwich components.

The reaction mixture may also be injected or poured without constraint onto surfaces or into open cavities. This process can be used to insulate roofs or complicated vessels in situ.

Another preferred embodiment of the process of the invention is continuous mixing of the isocyanate component with the polyol component to produce sandwich components or insulation components on twin-belt systems. The usual method with this technology is to meter the catalysts and the blowing agents into the polyol component by way of other metering pumps. The components used here may be divided into up to 8 separate components. Using the two-component process as a basis, the foaming formulations may readily be recalculated for the processing of multicomponent systems.

As stated above, the rigid polyurethane foams produced by the process of the invention have ideal processing properties, and in particular give good curing. Surprisingly, the rigid polyurethane foams produced by the process of the invention have reduced tendency toward cavitation.

The amount of isocyanate used to produce the foams can be reduced, since the hydroxy value of the graft polyols used is lower than that of conventional rigid-foam polyether alcohols.

The examples below are intended to provide an illustration of the invention in greater detail.

Test Methods

1) The bolt test was used to determine curing. In this test, 2, 3, and 4 minutes after mixing of the components in a polystyrene beaker a steel bolt with a spherical head of radius 10 mm was pressed to a depth of 10 mm into the resultant foam cushion, using a tensile/pressure testing machine. The maximum force required for this in N is a measure of the curing of the foam. The data given in each case is the total of the maximum forces measured after 2, 3 and 4 minutes.
2) Flowability was determined using the hose test. For this, 100 g of the reaction mixture obtained by mixing of the components was poured into a plastic hose of diameter 45 mm, and the hose is sealed. The length of the flow path within the plastic hose in cm is a measure of flowability.
3) Thermal conductivity was determined to DIN 52 616-77. The test specimens were produced by pouring the polyurethane reaction mixture into a mold of dimensions 22.5×22.5×22 cm (10% overfilling) and cutting a test specimen of dimensions 20×20×5 cm from the center after some hours.
4) Compressive strength was determined to DIN 52 421/DIN EN ISO 604.
5) Visual assessment of foam structure/fine cells in foam. 1: very fine-celled; 2: fine-celled; 3: slight degree of coarse-celled structure; 4: coarse-celled. The proportion of closed cells was determined to ISO 4590.
6) Visual assessment of tendency of sandwich components to develop base-surface defects or to develop cavities. 1: very smooth surface, no cavities/base-surface defects of any kind on underside of sandwich component; 2: very few slight cavities/base-surface defects on underside of sandwich component; 3: some cavities/base-surface defects on underside of sandwich component; 4: substantial base-surface defects across entire surface of underside of sandwich component
7) Assessment of curing of sandwich components at end of belt: 1: minimal change in component thickness after 24 hours; 2: slight change in component thickness after 24 hours; 3: marked change in component thickness after 24 hours
8) Fire performance was determined in the DIN 4102 small burner test
   Preparation of Graft Polyols
   Semi-Batch Preparation of Graft Polyols

Semi-batch preparation of graft polyols took place in a 2-liter autoclave equipped with 2-stage stirrer, internal cooling coil, and electrical heating jacket. Prior to start of the reaction, the reactor was charged with a mixture of carrier polyol and macromer, flushed with nitrogen, and heated to the synthesis temperature of 125 or 130° C. For some syntheses, a graft polyol (polyol 28) was also added as seed to the initial charge for the reaction, alongside the carrier polyol and the macromer.

The remainder of the reaction mixture, composed of further carrier polyol, initiator, the monomers, and the reaction moderator, formed an initial charge in at least two feed vessels. The graft polyols were synthesized by transferring the raw materials from the feed vessels at a constant metering rate by way of a static in-line mixer into the reactor. The feed time for the monomer-moderator mixture was 150 or 180 minutes, while the polyol-initiator mixture was metered into the reactor during 165 or 195 minutes. After a further period of from 10 to 30 minutes of continued reaction time at reaction temperature, the crude graft polyol was transferred by way of the basal discharge valve into a glass flask. The product was then freed from unreacted monomers and other volatile components at 135° C. in vacuo (<0.1 mbar). The final product was finally stabilized with antioxidants.

TABLE 0
Graft polyols from semi-batch preparation

| | Polyol 20 | Polyol 21 | Polyol 23 | Polyol 24 | Polyol 27 | Polyol 28 |
|---|---|---|---|---|---|---|
| Reaction conditions | | | | | | |
| Temperature (° C.) | 125 | 120 | 130 | 125 | 125 | 125 |
| Initial pressure (bar) | 0 | 0 | 0 | 3 | 3 | 1 |
| Initial reactor charge | | | | | | |
| Carrier Polyol (g) | Polyol 13 | Polyol 14 | Polyol 13 | Polyol 12 | Polyol 15 | Polyol 15 |
| | 214.17 | 275.2 | 336.70 | 356.07 | 356.07 | 336.58 |
| Macromer (g) | Polyol 16 | Polyol 16 | Polyol 16 | Polyol 16 | Polyol 16 | Polyol 16 |
| | 27.36 | 22.8 | 18.24 | 23.38 | 23.38 | 18.14 |
| Seed (g) | — | — | Polyol 28 | Polyol 28 | Polyol 28 | — |
| | | | 60.00 | 122.10 | 122.10 | |
| Feed stream 1 | | | | | | |
| Acrylonitrile (g) | 239.98 | 199.98 | 159.98 | 205.02 | 205.02 | 159.98 |
| Styrene (g) | 480.02 | 400.02 | 320.02 | 410.10 | 410.10 | 320.02 |
| n-Dodecanethiol (g) | 7.27 | 6.06 | 4.85 | 6.46 | 6.46 | 5.23 |
| Feed time (min) | 180 | 180 | 150 | 150 | 150 | 150 |
| Feed stream 2 | | | | | | |
| Carrier polyol (g) | Polyol 13 | Polyol 14 | Polyol 13 | Polyol 12 | Polyol 15 | Polyol 15 |
| | 227.60 | 292.23 | 357.81 | 378.4 | 378.4 | 357.68 |
| Initiator (g) | Initiator 1 | Initiator 2 | Initiator 1 | Initiator 1 | Initiator 1 | Initiator 3 |
| | 3.60 | 3.48 | 2.40 | 2.86 | 2.86 | 2.36 |
| Feed time (min) | 195 | 195 | 165 | 165 | 165 | 165 |

Continuous Preparation of Polyol 22

For continuous preparation of graft polyols under superatmospheric pressure, use was made of a 300 ml stirred reactor with continuous in- and outflow. Prior to the start of the reaction, the reactor was filled with polyol 12 or graft polyol from the preceding synthesis, and heated to the synthesis temperature of 133° C. The reaction mixture was provided in two feed vessels, and pumped into the reactor, using the feed rates given.

| Feed stream 1 | Feed rate: 14.54 g/min | |
|---|---|---|
| Acrylonitrile | 449.96 | g |
| Styrene | 900.05 | g |
| Isopropanol | 202.50 | g |
| Feed stream 2 | Feed time: 15.46 g/min | |
| Polyol 12 | 1578.45 | g |
| Polyol 16 | 60.75 | g |
| Initiator 2 | 10.80 | g |

Prior to entry into the reactor, the two feed streams were combined by way of an in-line static mixer. The product obtained during the initial phase was discarded. Continuous operating conditions are usually achieved when the turnover factor has reached 10, corresponding to about 3000 ml.

The reaction mixture was pumped into the reactor by way of an aperture in the base, and intimately mixed by stirring (1500 rpm) with the material previously introduced thereto, and was discharged from the reactor by way of a controllable spring-loaded retention valve at the head of the reactor. The pressure in the reactor was maintained at from 4 to 10 bar, the reaction temperature being from 140 to 145° C. After discharge from the reactor, the crude graft polyol, now at atmospheric pressure was collected in a glass flask. The product was then freed from unreacted monomers and other volatile compounds at 135° C. in vacuo (<0.1 mbar). The final product was finally stabilized, using antioxidants.

### EXAMPLES 1 TO 8 AND COMPARATIVE EXAMPLES 1 TO 4

### Comparative Example 1

### Rigid Foam for Use in Refrigeration Equipment; Manual Foaming

A polyol component was prepared by mixing 54.4 parts by weight of a polyether alcohol based on sorbitol and propylene oxide and having a hydroxy value of 490 mg KOH/g (polyol 1), 25.0 parts by weight of a polyether alcohol based on sucrose, glycerol, and propylene oxide, hydroxy value: 490 mg KOH/g (polyol 2), 0.8 part by weight of glycerol, 1.7 parts by weight of silicone stabilizer L 6900 from Crompton, 1.3 parts by weight of water, 0.7 part by weight of N,N-dimethylcyclohexylamine, 1.1 parts by weight of Lupragen® N301, BASF Aktiengesellschaft, and 0.6 part by weight of Lupragen® N600, BASF Aktiengesellschaft, and 14 parts by weight of cyclopentane.

100 parts by weight of polyol component were mixed with 150 parts 40 by weight of a mixture of diphenylmethane diisocyanate and polyphenylene polymethylene polyisocyanate having a NCO content of 31.5% by weight and a viscosity of 200 mPas (25° C.). This corresponds to an index of 132. The mixture was mixed using a Vollrath agitator with a maximum rotation rate of 1500 rpm, and then permitted to cure without restraint.

The envelope density of the resultant foam was 30 g/l and its thermal conductivity was 20.5 mW/mK. Its curing level, determined from the average of the impression hardness measurements after 2, 3, and 4 minutes, was 135 N. The proportion of open cells was 10%.

### Example 1

(Rigid Foam for Use in Refrigeration Equipment)

The procedure was as in comparative example 1, but polyol 2 was reduced by 25 parts by weight, these being replaced by 25 parts by weight of a graft polyol having a hydroxy value of 60.2 mg KOH/g, a solids content of 60% by weight, and a viscosity of 30 000 mPas at 25° C., prepared by polymerizing acrylonitrile and styrene in situ in a ratio of 1:2 by weight in a carrier polyol based on trimethylolpropane and propylene oxide and having a hydroxy value of 160 mg KOH/g (polyol 20).

100 parts by weight of polyol component were mixed with 113 parts by weight of a mixture of diphenylmethane diisocyanate and polyphenylene polymethylene polyisocyanate having an NCO content of 31.5% by weight and a viscosity of 200 mPas (25° C.). This corresponds to an index of 132. The mixture was mixed using a Vollrath agitator with a maximum rotation rate of 1500 rpm, and then permitted to cure without restraint.

The envelope density of the resultant foam was 30 g/l and its thermal conductivity was 19.2 mW/mK. Its curing level, determined from the average of the impression hardness measurements after 2, 3, and 4 minutes, was 177 N. The proportion of open cells was 9%.

Examples 2 to 6 and comparative example 2 used the same process. The raw materials used are shown in table 1, as are the foam properties determined.

### Comparative Example 2

(Rigid Foam for Use in Refrigeration Equipment; Machine Foaming)

A polyol component was prepared by mixing 20 parts by weight of polyol 1, 35.6 parts by weight of a polyether alcohol based on sucrose, pentaerythritol, diethylene glycol, and propylene oxide having a hydroxy value of 400 mg KOH/g (polyol 3), 30 parts by weight of a polyether alcohol made from vicinal tolylenediamine, ethylene oxide, and propylene oxide, having a hydroxy value of 45 400 mg KOH/g (polyol 4), 7 parts by weight of castor oil, 3 parts by weight of silicone stabilizer Tegostab B 8467 from Degussa, 2.3 parts by weight of water, 0.7 part by weight of dimethylcyclohexylamine, 0.7 part by weight of Lupragen® N301, BASF Aktiengesellschaft, 0.7 part by weight of Dabco® T from Air Products, and 14 parts by weight of cyclopentane.

100 parts by weight of polyol component were mixed with 134 parts by weight of a mixture of diphenylmethane diisocyanate and polyphenylene polymethylene polyisocyanate having an NCO content of 31.5% by weight and a viscosity of 200 mPas (25° C.) in a Puromat® HD 30 high-pressure foaming machine (Elastogran GmbH). This corresponds to an index of 122. The reaction mixture was injected into a mold of dimensions 200×20×5 cm (Bosch lance) or 40×70×9 cm, where it was foamed.

The properties of the foam are given in table 2.

### Example 4

(Rigid Foam for Use in Refrigeration Equipment)

The procedure was as in comparative example 2, but polyol 3 was reduced by 25 parts by weight, these being replaced by 25 parts by weight of a graft polyol having a hydroxy value of 20 mg KOH/g, a solids content of 45% by weight, and a viscosity of 8000 mPas at 25° C., prepared by polymerizing acrylonitrile and styrene in situ in a ratio of 1:2 by weight in a carrier polyol based on glycerol, propylene oxide, and ethylene oxide, having a hydroxy value of 35 mg KOH/g. (Polyol 22).

100 parts by weight of polyol component were mixed with 114 parts by weight of a mixture of diphenylmethane diisocyanate and polyphenylene polymethylene polyisocyanate with a NCO content of 31.5% by weight and a viscosity of 200 mPas (25° C.). This corresponds to an index of 125. The reaction mixture was injected into a mold of dimensions 200×20×5 cm or 40×70×9 cm, where it was foamed.

Examples 7 and 8 and comparative examples 3 and 4 used the same process. The raw materials used are shown in table 2, as are the foam properties determined.

TABLE 1
Production of foams (manual foaming)

| | Comparative | | | | Comparative | | | |
|---|---|---|---|---|---|---|---|---|
| | example 1 | Example 1 | Example 2 | Example 3 | ex. 2 | Example 4 | Example 5 | Example 6 |
| Polyol 1 | 54.4 | 54.4 | 54.4 | 54.4 | 20 | 20 | 20 | 20 |
| Polyol 2 | 25 | | 15 | | | | | |
| Polyol 3 | | | | | 35.6 | 10.6 | 25.6 | 10.6 |
| Polyol 4 | | | | | 30 | 30 | 30 | 30 |
| Glycerol | 0.8 | 0.8 | 0.8 | 0.8 | | | | |
| Polyol 20 | | 25 | 10 | | | | | |
| Polyol 21 | | | | 25 | | | | 25 |
| Polyol 22 | | | | | | 25 | 10 | |
| Castor oil | | | | | 7 | 7 | 7 | 7 |
| Stabilizer 1 | 1.7 | 1.7 | 1.7 | 1.7 | | | | |
| Stabilizer 2 | | | | | 3 | 3 | 3 | 3 |
| Water | 1.3 | 1.3 | 1.3 | 1.3 | 2.3 | 2.3 | 2.3 | 2.3 |
| Catalyst 1 | 0.7 | 0.7 | 0.7 | 0.7 | 0.7 | 0.7 | 0.7 | 0.7 |
| Catalyst 2 | 1.1 | 1.1 | 1.1 | 1.1 | 0.7 | 0.7 | 0.7 | 0.7 |
| Catalyst 3 | 0.6 | 0.6 | 0.6 | 0.6 | | | | |
| Catalyst 4 | | | | | 0.7 | 0.7 | 0.7 | 0.7 |
| Cyclopentane | 14 | 14 | 14 | 14 | 14 | 14 | 14 | 14 |
| Mixing ratio 100: | 150 | 113 | 144 | 125 | 134 | 114 | 127 | 117 |
| Index | 132 | 132 | 132 | 132 | 125 | 125 | 125 | 125 |
| Cream time [s] | 8 | 7 | 8 | 7 | 8 | 9 | 9 | 8 |
| Fiber time [s] | 50 | 49 | 52 | 48 | 53 | 58 | 57 | 56 |
| Envelope density | 30 | 30 | 29 | 30 | 28 | 28 | 27 | 28 |
| [g/l] | | | | | | | | |
| Open cells [%] | 10 | 9 | 10 | 11 | 9 | 8 | 10 | 11 |
| Bolt test [N/mm²] | 135 | 177 | 152 | 172 | 64 | 101 | 85 | 99 |
| Thermal conductivity | 20.5 | 19.2 | 19.9 | 19.4 | 19.1 | 20.3 | 19.8 | 20.1 |
| [mW/mK] | | | | | | | | |

TABLE 2
Production of foams (machine foaming)

| | Comparative | | Comparative | | Comparative | |
|---|---|---|---|---|---|---|
| | example 2 | Example 4 | example 3 | Example 7 | example 4 | Example 8 |
| Polyol 1 | 20 | 20 | 20 | 20 | 20 | 20 |
| Polyol 3 | 35.6 | 10.6 | 35.6 | 10.6 | 35.6 | 10.6 |
| Polyol 4 | 30 | 30 | 30 | 30 | 30 | 30 |
| Polyol 22 | | 25 | | 25 | | 25 |
| Castor oil | 7 | 7 | 7 | 7 | 7 | 7 |
| Stabilizer 2 | 3 | 3 | 3 | 3 | 3 | 3 |
| Water | 2.3 | 2.3 | 2.3 | 2.3 | 2.3 | 2.3 |
| Catalyst 1 | 0.7 | 0.7 | 0.7 | 0.7 | 0.7 | 0.7 |
| Catalyst 2 | 0.7 | 0.7 | 0.7 | 0.7 | 0.7 | 0.7 |
| Catalyst 4 | 0.7 | 0.7 | 0.7 | 0.7 | 0.7 | 0.7 |
| Cyclopentane | 14 | 14 | 9.8 | 9.8 | 12.7 | 12.7 |
| Isopentane | | | 4.2 | 4.2 | | |
| Isobutane | | | | | 1.3 | 1.3 |
| Mixing ratio 100: | 134 | 114 | 134 | 114 | 134 | 114 |
| Index | 132 | 132 | 132 | 132 | 132 | 132 |
| Fiber time [s] | 44 | 41 | 47 | 45 | 47 | 44 |
| Free-foamed envelope density | 22.0 | 22.5 | 20.8 | 20.7 | 20.2 | 20.6 |
| [g/l] | | | | | | |
| Minimum apparent density | 31.8 | 31.2 | 29.5 | 28.3 | 28.8 | 28.3 |
| [g/l] | | | | | | |
| Flow factor (min. apparent | 1.45 | 1.39 | 1.41 | 1.37 | 1.42 | 1.39 |
| density/free envelope density) | | | | | | |
| Open cells [%] | 6 | 7 | 5 | 8 | 6 | 6 |
| Thermal conductivity | 19.3 | 19.2 | 19.4 | 19.2 | 19.2 | 19.1 |
| [mW/mK] | | | | | | |
| Compressive strength (RD 35) | 0.135 | 0.12 | 0.13 | 0.12 | 0.135 | 0.12 |
| [N/mm²] | | | | | | |
| Continued expansion after 24 h, | 91.3 | 90.5 | 91.1 | 90.6 | 91.1 | 90.4 |
| 10% overpack [mm] | | | | | | |

### EXAMPLES 10 TO 27 AND COMPARATIVE EXAMPLES 5 TO 7

(Production of Sandwich Components)

A polyol component was prepared from the starting materials listed in tables 3, 4 and 5, and reacted in the stated mixing ratio on a twin-belt system with a mixture of diphenylmethane diisocyanate and polyphenylene polymethylene polyisocyanate with an NCO content of 31.0% by weight and a viscosity of 520 mPas (25° C.) to produce a sandwich component with a thickness of from 80 to 120 mm.

Tables 3 to 5 list the raw materials used and the properties of the sandwich components.

TABLE 3

| | Compar- | | | | | | | |
|---|---|---|---|---|---|---|---|---|
| | ative | Example | Example | Example | Example | Example | Example | Example |
| | example 5 | 10 | 11 | 12 | 13 | 14 | 15 | 16 |
| Polyol 2 | 20 | 20 | 20 | 20 | 20 | 20 | 20 | 20 |
| Polyol 5 | 18.5 | 18.5 | 18.5 | 18.5 | 18.5 | 18.5 | 18.5 | 18.5 |
| Polyol6 | 16 | 16 | 16 | 16 | 16 | 16 | 16 | 16 |
| Polyol 7 | 20 | 20 | 20 | 20 | 20 | 20 | 20 | 20 |
| Polyol8 | 10 | 10 | 10 | 10 | 10 | 10 | 10 | 10 |
| Glycerol | 2 | 2 | 2 | 2 | 2 | 2 | 2 | 2 |
| Dipropylene glycol | 0.2 | 0.2 | 0.2 | 0.2 | 0.2 | 0.2 | 0.2 | 0.2 |
| Polyol2l | | 5 | | | | | | |
| Polyol 23 | | | 10 | 5 | | | | |
| Polyol 24 | | | | | 5 | | | |
| Polyol 25 | | | | | | 5 | 4.5 | |
| Polyol 26 | | | | | | | | 5 |
| Flame retardant 1 | 12 | 12 | 12 | 12 | 12 | 12 | 12 | 12 |
| Stabilizer 3 | 1 | 1 | 1 | 1 | 1 | 1 | 1.5 | 1 |
| Catalyst 1 | 4.6 | 4.6 | 4.6 | 4.6 | 4.6 | 4.6 | 4.6 | 4.6 |
| Water | 2.53 | 2.53 | 2.53 | 2.53 | 2.53 | 2.53 | 2.53 | 2.53 |
| n-Pentane | 7.0 | 7.0 | 7.0 | 7.0 | 7.0 | 7.0 | 7.0 | 7.0 |
| Mixing ratio 100: | 119 | 119 | 119 | 119 | 119 | 119 | 119 | 119 |
| Cream time [s] | 15 | 15 | 14 | 15 | 16 | 15 | 15 | 16 |
| Fiber time [s] | 45 | 45 | 44 | 45 | 46 | 44 | 45 | 47 |
| Envelope density [g/l] | 42 | 41 | 42 | 43 | 42 | 44 | 42 | 43 |
| Component thickness | 80 | 80 | 80 | 80 | 80 | 80 | 80 | 80 |
| [mm] | | | | | | | | |
| Bolt test [N] | 168 | 206 | 225 | 211 | 222 | 230 | 215 | 221 |
| Open cells [%] | 8 | 10 | 10 | 8 | 11 | 10 | 9 | 9 |
| Fire performance | B3 | B3 | B3 | B3 | B3 | B3 | B3 | B3 |
| (DIN 4102) | | | | | | | | |
| Curing at end of belt | 3 | 2 | 1 | 1-2 | 1-2 | 1-2 | 1-2 | 1-2 |
| Cavitation frequency | 3 | 2-3 | 1-2 | 2 | 1-2 | 1-2 | 2 | 2 |
| Foam structure | 2 | 2 | 2 | 2 | 2 | 2 | 2 | 2 |

TABLE 4

| | Comparative | | | | | | |
|---|---|---|---|---|---|---|---|
| | example 6 | Example 17 | Example 18 | Example 19 | Example 20 | Example 21 | Example 22 |
| Polyol 2 | 51.15 | 51.15 | 51.15 | 51.15 | 51.15 | 51.15 | 51.15 |
| Polyol 9 | 5 | 5 | 5 | 5 | 5 | 5 | 5 |
| Glycerol | 4.5 | 4.5 | 4.5 | 4.5 | 4.5 | 4.5 | 4.5 |
| Dipropylene glycol | 0.2 | 0.2 | 0.2 | 0.2 | 0.2 | 0.2 | 0.2 |
| Polyol 20 | | 5 | | | | | |
| Polyol 23 | | | 5 | | | | |
| Polyol 24 | | | | 5 | | | |
| Polyol 25 | | | | | 5 | | |
| Polyol 27 | | | | | | 10 | 5 |
| Flame retardant 1 | 20 | 20 | 20 | 20 | 20 | 20 | 20 |
| Flame retardant 2 | 5 | 5 | 5 | 5 | 5 | 5 | 5 |
| Flame retardant 3 | 12.5 | 12.5 | 12.5 | 12.5 | 12.5 | 12.5 | 12.5 |
| Stabilizer 4 | 1.3 | 1.3 | 0.5 | 0.5 | 0.5 | 0.5 | 0.5 |
| Stabilizer 5 | 0.5 | 0.5 | 0.5 | 0.5 | 0.5 | 0.5 | 0.5 |
| Catalysts | 3.1 | 3.1 | 3.1 | 3.1 | 3.1 | 3.1 | 3.1 |
| Water | 2.55 | 2.55 | 2.55 | 2.55 | 2.55 | 2.55 | 2.55 |
| n-Pentane | 6.0 | 6.0 | 6.0 | 6.0 | 6.0 | 6.0 | 6.0 |
| Mixing ratio 100: | 126 | 126 | 126 | 126 | 126 | 126 | 126 |
| Cream time [s] | 17 | 16 | 17 | 18 | 18 | 17 | 17 |
| Fiber time [s] | 45 | 44 | 45 | 46 | 46 | 44 | 45 |
| Envelope density [g/l]/ | 40 | 41 | 40 | 40 | 39 | 40 | 40 |
| Component thickness [mm] | 120 | 120 | 120 | 120 | 120 | 120 | 120 |
| Open cells [%] | 8 | 9 | 11 | 10 | 10 | 9 | 11 |
| Bolt test [N] | 120 | 185 | 194 | 201 | 203 | 231 | 206 |
| Fire performance (DIN 4102) | B2 | B2 | B2 | B2 | B2 | B2 | B2 |
| Curing at end of belt | 3 | 2 | 1-2 | 1-2 | 1-2 | 1 | 1-2 |
| Cavitation frequency | 3 | 2 | 1-2 | 1-2 | 2 | 1-2 | 1-2 |
| Foam structure | 2 | 2 | 2 | 2 | 22 | 2 | 2 |

TABLE 5

| | Comparative | | | | | |
|---|---|---|---|---|---|---|
| | example 7 | Example 23 | Example 24 | Example 25 | Example 26 | Example 27 |
| Polyol 11 | 31.14 | 31.14 | 31.14 | 31.14 | 31.14 | 31.14 |
| Polyol 12 | 38.47 | 38.47 | 38.47 | 38.47 | 38.47 | 38.47 |
| Polyol 24 | | 2 | | | | |
| Polyol 25 | | | 5 | 4.5 | | |
| Polyol 26 | | | | | 5 | |
| Polyol 27 | | | | | | 5 |
| Dipropylene glycol | 20.25 | 20.25 | 20.25 | 20.25 | 20.25 | 20.25 |
| Ethylene glycol | 3.3 | 3.3 | 3.3 | 3.3 | 3.3 | 3.3 |
| Stabilizer 6 | 3.12 | 3.12 | 3.12 | 3.62 | 3.12 | 3.12 |
| Catalyst 2 | 0.32 | 0.32 | 0.32 | 0.32 | 0.32 | 0.32 |
| Catalyst 6 | 2.93 | 2.93 | 2.93 | 2.93 | 2.93 | 2.93 |
| Water | 0.47 | 0.47 | 0.47 | 0.47 | 0.47 | 0.47 |
| Cyclopentane | 17 | 17 | 17 | 17 | 17 | 17 |
| Mixing ratio 100: | 300 | 300 | 300 | 300 | 300 | 300 |
| Cream time [s] | 18 | 17 | 18 | 16 | 19 | 18 |
| Fiber time [s] | 29 | 30 | 29 | 29 | 31 | 30 |
| Envelope density [g/l] | 69 | 70 | 69 | 69 | 69 | 70 |
| Component thickness [mm] | 80 | 80 | 80 | 80 | 80 | 80 |
| Open cells [%] | 7 | 8 | 6 | 7 | 5 | 7 |
| Fire performance (DIN 4102) | B3 | B3 | B3 | B3 | B3 | B3 |
| Curing at end of belt | 3 | 2-3 | 1-2 | 1-2 | 1-2 | 1 |
| Cavitation frequency | 3 | 2-3 | 1-2 | 1 | 1 | 1-2 |
| Foam structure | 2 | 2 | 2 | 2 | 2 | 2 |

Raw Materials Used:
Polyol 1: Polyether alcohol based on sorbitol, propylene oxide, hydroxy value: 500 mg KOH/g
Polyol 2: Polyether alcohol based on sucrose, glycerol, and propylene oxide, hydroxy value: 490 mg KOH/g
Polyol 3: Polyether alcohol based on sucrose, pentaerythritol, diethylene glycol, and propylene oxide, hydroxy value: 400 mg KOH/g
Polyol 4: Polyether alcohol made from vicinal tolylenediamine, ethylene oxide, and propylene oxide, hydroxy value:
400 mg KOH/g
Polyol 5: Polyether alcohol based on sucrose, diethylene glycol, and propylene oxide, hydroxy value: 440 mg KOH/g
Polyol 6: Polyether alcohol based on propylene glycol and propylene oxide, hydroxy value: 105 mg KOH/g
Polyol 7: Polyether alcohol based on sorbitol and propylene oxide, hydroxy value: 340 mg KOH/g
Polyol 8: Polyester alcohol based on industrial dimer fatty acid, glycerol, hydroxy value: 400 mg KOH/g
Polyol 9: Polyether alcohol based on ethylenediamine and propylene oxide, hydroxy value: 770 mg KOH/g
Polyol 10: Polyether alcohol based on propylene glycol and propylene oxide, hydroxy value: 250 mg KOH/g
Polyol 11: Polyester alcohol prepared from adipic acid, phthalic anhydride, oleic acid, and 1,1,1-trimethylolpropane, hydroxy value 385 mg KOH/g
Polyol 12: Polyether alcohol based on glycerol, ethylene oxide, and propylene oxide, hydroxy value: 35 mg KOH/g
Polyol 13: Polyether alcohol based on trimethylolpropane and propylene oxide, hydroxy value: 160 mg KOH/g
Polyol 14: Polyether alcohol based on tolylenediamine, ethylene oxide, and propylene oxide, hydroxy value: 160 mg KOH/g
Polyol 15: Polyether alcohol based on glycerol, ethylene glycol, ethylene oxide, and propylene oxide, hydroxy value: 48 mg KOH/g
Polyol 16: Monofumarate ester having a hydroxy value of 18.8 mg KOH/g and a viscosity of 7400 mPas, prepared by reacting maleic anhydride with a polyol based on trimethylolpropane, propylene oxide, and ethylene oxide, having a hydroxy value of 26.6 mg KOH/g.
Polyol 20: Graft polyol having a hydroxy value of 60.2 mg KOH/g, a solids content of 60% by weight, and a viscosity of 30 000 mPas at 25° C., prepared by polymerizing acrylonitrile and styrene in situ in a ratio of 1:2 by weight in a carrier polyol based on trimethylolpropane and propylene oxide, hydroxy value: 160 mg KOH/g
Polyol 21: Graft polyol having a hydroxy value of 77 mg KOH/g, a solids content of 52% by weight, and a viscosity of 42 000 mPas at 25° C., prepared by polymerizing acrylonitrile and styrene in situ in a ratio of 1:2 by weight in a carrier polyol based on vicinal tolylenediamine, ethylene oxide, and propylene oxide, hydroxy value: 160 mg KOH/g
Polyol 22: Graft polyol having a hydroxy value of 20 mg KOH/g, a solids content of 45% by weight, and a viscosity of 9000 mPas at 25° C., prepared by polymerizing acrylonitrile and styrene in situ in a ratio of 1:2 by weight in a carrier polyol based on glycerol, propylene oxide, and ethylene oxide, hydroxy value: 35 mg KOH/g
Polyol 23: Graft polyol having a hydroxy value of 91 mg KOH/g, a solids content of 41% by weight, and a viscosity of 45 3000 mPas at 25° C., prepared by polymerizing acrylonitrile and styrene in situ in a ratio of 1:2 by weight in a carrier polyol based on trimethylolpropane and propylene oxide, hydroxy value: 160 mg KOH/g
Polyol 24: Graft polyol having a hydroxy value of 20 mg KOH/g, a solids content of 45% by weight, and a viscosity of 9000 mPas at 25° C., prepared by polymerizing acrylonitrile and styrene in situ in a ratio of 1:2 by weight in a carrier polyol based on trimethylolpropane and propylene oxide, hydroxy value: 35 mg KOH/g
Polyol 25: Mixture of 2 parts by weight of polyol 22 and 3 parts by weight of polyol 10
Polyol 26: Mixture of 2 parts by weight of polyol 22 and 3 parts by weight of polyol 6
Polyol 27: Graft polyol having a hydroxy value of 26 mg KOH/g, a solids content of 45% by weight, and a viscosity of 6000 mPas at 25° C., prepared by polymerizing acrylonitrile and styrene in situ in a ratio of 1:2 by weight in a carrier polyol based on glycerol, ethylene glycol, and propylene oxide and ethylene oxide, hydroxy value: 48 mg KOH/g
Polyol 28: Graft polyol having a hydroxy value of 28.4 mg KOH/g, a solids content of 41% by weight, and a viscosity of 4500 mPas at 25° C., prepared by polymerizing acrylonitrile and styrene in situ in a ratio of 1:2 by weight in a carrier polyol based on glycerol and monoethylene glycol, ethylene oxide and propylene oxide, hydroxy value: 48 mg KOH/g
Flame retardant 1: Trischloropropyl phosphate
Flame retardant 2: Diethyl ethanephosphonate
Flame retardant 3: Ixol® B251, Solvay AG
Stabilizer 1: L6900, Crompton Corp.
Stabilizer 2: Tegostab® B8467, Degussa AG
Stabilizer 3: OS340, Bayer AG
Stabilizer 4: Tegostab® B8466, Degussa AG
Stabilizer 5: Dabco® DC5103, Air Products
Stabilizer 6: 1:1 mixture of Tegostab® B8461 and Tegostab® B8409, Degussa AG
Catalyst 1: N,N-Dimethylcyclohexylamine
Catalyst 2: Lupragen® N301, BASF Aktiengesellschaft
Catalyst 3: Lupragen® N600, BASF Aktiengesellschaft
Catalyst 4: Dabco® T, Air Products
Catalyst 5: KX315, Elastogran GmbH
Catalyst 6: 47% strength solution of potassium acetate in ethylene glycol
Initiator 1: Trigonox® 121, Akzo Nobel Chemikals GmbH
Initiator 2: Vazo® 67, Du Pont de Nemours GmbH
Initiator 3: Wako® V 601, Wako Chemicals GmbH

1. A process for producing closed-celled rigid polyurethane foams by reacting
a) crude MDI having an NCO content of from 29 to 33% by weight and a viscosity at 25° C. in the range from 150 to 1000 mPa·s with
b) compounds having at least two hydrogen atoms reactive toward isocyanate groups, in the presence of
c) catalysts, and
d) blowing agents,
which comprises the presence, among the compounds having at least two hydrogen atoms reactive toward isocyanate groups, of at least one graft polyol capable of preparation via in-situ polymerization of ethylenically unsaturated monomers in polyether alcohols.

2. A process as claimed in claim 1, wherein the amount used of the graft polyols is up to 100% by weight, based on component b.

3. A process as claimed in claim 1, wherein the amount used of the graft polyols is from 0.5 to 70% by weight, based in each case on component b.

4. A process as claimed in claim 1, wherein the amount used of the graft polyols during the production of rigid polyurethane foams for use in refrigeration equipment is from 3 to 70% by weight, based on component b.

5. A process as claimed in claim 1, wherein the amount used of the graft polyols during the production of rigid polyurethane foams for use in sandwich components is from 0.5 to 35% by weight, based on component b.

6. A process as claimed in claim 1, wherein the graft polyols have a hydroxy value in the range from 20 to 210 mg KOH/g.

7. A process as claimed in claim 1, wherein the graft polyol particle distribution has a maximum at from 0.1 to 8 μm.

8. A process as claimed in claim 1, wherein the graft polyols have bimodal particle size distribution with two clearly separated maxima for the polymers.

9. A process as claimed in claim 1, wherein the graft polyols are prepared by in-situ polymerization of ethylenically unsaturated monomers in polyether alcohols having a functionality of from 2 to 8 and having a hydroxy value in the range from 100 to 800 mg KOH/g, obtainable by an addition reaction of alkylene oxides onto H-functional starter substances, the starter substances having been selected from the group consisting of polyfunctional alcohols, sugar alcohols, aliphatic amines, and aromatic amines.

10. A process as claimed in claim 1 wherein the graft polyols can be prepared by in-situ polymerization of ethylenically unsaturated monomers in polyether alcohols which are obtained by an addition reaction of alkylene oxides onto tolylenediamine, using basic catalysis.

11. A process as claimed in claim 1, wherein the graft polyols can be prepared by in-situ polymerization of ethylenically unsaturated monomers in polyether alcohols which are obtained by an addition reaction of alkylene oxides onto trimethylolpropane, using basic catalysis or catalysis by multimetal cyanide complexes.

12. A rigid polyurethane foam produced by the process of claim 1.

13. A graft polyol capable of preparation by in-situ polymerization of ethylenically unsaturated monomers in polyether alcohols having a hydroxy value in the range from 100 to 600 mg KOH/g, obtainable by an addition reaction of alkylene oxides onto H-functional starter substances, the starter substances having been selected from the group consisting of polyfunctional alcohols, sugar alcohols, aliphatic amines, and aromatic amines.

14. A graft polyol as claimed in claim 13, by in-situ polymerization of ethylenically unsaturated monomers in polyether alcohols having a hydroxy value in the range from 140 to 240 mg KOH/g, which are obtained by an addition reaction of alkylene oxides onto tolylenediamine.

15. A graft polyol as claimed in claim 13, by in-situ polymerization of ethylenically unsaturated monomers in polyether alcohols having a hydroxy value in the range from 140 to 240 mg KOH/g, which are obtained by an addition reaction of alkylene oxides onto trimethylolpropane.
